(19) United States
(12) Patent Application Publication
(10) Pub. No.: US 2023/0013139 A1
(43) Pub. Date: Jan. 19, 2023

(54) FEATURE REGION TRACKING PROCESS METHOD, VITAL INFORMATION ESTIMATING METHOD USING FEATURE REGION TRACKING PROCESS METHOD, FEATURE REGION TRACKING PROCESS DEVICE, AND VITAL INFORMATION ESTIMATING DEVICE USING FEATURE REGION TRACKING PROCESS

(71) Applicant: PANASONIC INTELLECTUAL PROPERTY MANAGEMENT CO., LTD., Osaka (JP)

(72) Inventor: Masao HAMADA, Fukuoka (JP)

(73) Assignee: PANASONIC INTELLECTUAL PROPERTY MANAGEMENT CO., LTD., Osaka (JP)

(21) Appl. No.: 17/783,222

(22) PCT Filed: Dec. 9, 2020
(86) PCT No.: PCT/JP2020/045905

§ 371 Date: Jun. 7, 2022

(30) Foreign Application Priority Data
Dec. 9, 2019 (JP) 2019-222366

(51) Int. Cl. G06T 7/73

(52) U.S. Cl. CPC G06T 7/73; G06T 2207/30201

(57) ABSTRACT

A feature region tracking process method includes temporarily stopping the output of camera images being successively acquired; accumulating, as accumulated image data, respective camera images that are successively acquired after the time of temporal stoppage, starting from the time of temporal stoppage; accepting position designation in a camera image being output at the time of temporal stoppage; and, when the position designation has been accepted, performing a tracking process in sequence on a feature region in the camera images included in the accumulated image data from the camera image acquired at the time of temporal stoppage to the latest camera image, using the designated position as the feature region.

### TECHNICAL FIELD

The present disclosure relates to a feature region tracking processing method for performing tracking processing on a subject, a vital information estimating method using the feature region tracking processing method, a feature region tracking processing device, and a vital information estimating device using the feature region tracking processing device.

### BACKGROUND ART

In the related art, an object tracking algorithm in a video is also used for a person automatic tracking function of a monitoring camera or a face tracking function of a Web camera. For example, in a field of sports, the video object tracking algorithm is used when an athlete in a competition is tracked and photographed.

Meanwhile, a vital analysis technology is expected to be applied not only to home care and health management but also to various fields such as drowsiness detection during driving, acquisition of a psychological state of a user during a game, and detection of an abnormal person in a monitoring system by using estimated vital information of a person. In the field of sports among the various fields, vital information of a player is used to estimate a state of the player, adjust an exercise load, and prevent injury or failure during a competition. In particular, there are many demands for real-time analysis during the competition, but a contact type vital analysis device may be prohibited from being loaded on the player or being worn in the competition and a match, and therefore non-contact type vital analysis using a camera is taken.

In a tracking processing on a feature region such as a face in a video or the non-contact type vital analysis using the camera, for example, the user needs to designate a feature region of a subject serving as a target of the tracking process or the vital analysis. When the subject is photographed as a moving image, the user needs to designate the feature region to be subjected to the tracking processing or the vital analysis while checking the subject on successive images in real time. Therefore, there is a problem in that it is difficult to designate the target feature region when the subject moves vigorously.

Here, as disclosed in PTL 1, there is known an automatic tracking process photographing device including a temporary stop type target subject designation unit that receives designation of a target subject present in a temporarily stopped image and accumulates an image newly acquired by a photographing unit in an accumulation unit during the temporary stop, a target subject search unit that successively searches images successively accumulated in the accumulation unit during the temporary stop for a position of the target subject, and a photographing direction change unit that controls a direction of the photographing unit based on a photographing range.

Further, as disclosed in PTL 2, a feature point tracking processing method is known in which a pulse rate of a user is estimated with high accuracy in a non-contact manner by image processing of a skin color region of the user included in image data obtained by photographing.

### CITATION LIST

### Patent Literature

[PTL 1] JP-A-2009-188905
[PTL 2] JP-A-2016-77539

### SUMMARY OF INVENTION

### Technical Problem

In the technique of PTL 1, a tracking processing start position can be designated in the temporarily stopped image, the images are successively recorded during the temporary stop, and the recorded images are searched for the subject, thereby enabling the tracking processing. However, there is a problem that, when the subject moves greatly during the temporary stop, it becomes difficult for the target subject search unit to view the subject and perform the tracking processing. On the other hand, in the technique of PTL 2, there is a problem that a test site is a part of the skin, a designated region is very narrow, a degree of difficulty is high in designating the test site on the photographed moving image, and the degree of difficulty is very high in analyzing a subject moving vigorously such as an athlete during a competition.

In view of the above-described situations, an object of the present disclosure is to provide a feature region tracking processing method, a vital information estimating method, a feature region tracking processing device, and a vital information estimation device that perform tracking processing after easily designating a feature region of a subject and extract vital information on the feature region even when the subject moves vigorously.

### Solution to Problem

The present disclosure provides a feature region tracking processing method including: temporarily stopping an output of successively acquired camera images; accumulating, as accumulated image data, respective camera images successively acquired after a time of the temporary stop treating the time of the temporary stop as a starting point; receiving position designation in a camera image output at the time of the temporary stop; and when the position designation is received, sequentially performing, by using a designated position as a feature region, tracking processing on feature regions in camera images from the camera image acquired at the time of the temporary stop to a latest camera image included in the accumulated image data, in which the tracking processing on the feature region of the latest camera image is completed at a timing at which the latest camera image is accumulated as the accumulated image data.

In addition, the present disclosure provides a feature region tracking processing device including: a camera image capturing unit configured to temporarily stop output of successively acquired camera images; an image accumulation buffer management unit configured to accumulate, as accumulated image data, respective camera images successively acquired after a time of the temporary stop, the time of the temporary stop being a starting point; a tracking processing position designation unit configured to receive position designation in the camera image output at the time of the temporary stop; and a tracking processing unit configured to sequentially perform, when the position designation is received, by using a designated position as a feature region, tracking processing on feature regions in camera images included in the accumulated image data from the camera image acquired at the time of the temporary stop to a latest camera image, in which the tracking processing unit completes the tracking processing on the feature region of the latest camera image at a timing at which the latest camera image is accumulated as the accumulated image data.

In addition, the present disclosure provides a vital information estimating device using the feature region tracking processing method including: a camera image capturing unit configured to temporarily stop output of successively acquired camera images; an image accumulation buffer management unit configured to accumulate, as accumulated image data, respective camera images successively acquired after a time of the temporary stop, the time of the temporary stop being a starting point; a tracking processing position designation unit configured to receive position designation in the camera image output at the time of the temporary stop; and a tracking processing unit configured to sequentially perform, when the position designation is received, by using a designated position as a feature region, tracking processing on feature regions in camera images included in the accumulated image data from the camera image acquired at the time of the temporary stop to a latest camera image, in which the tracking processing unit completes the tracking processing on the feature region of the latest camera image at a timing at which the latest camera image is accumulated as the accumulated image data.

### Advantageous Effects of Invention

According to the present disclosure, even when the subject moves vigorously, the tracking processing can be performed after the feature region of the subject is easily designated, and the vital information of the feature region can be extracted.

### BRIEF DESCRIPTION OF DRAWINGS

FIG. 1 is a configuration diagram showing an internal configuration example of a feature region tracking processing device according to the present embodiment.

FIG. 2 is a block diagram showing an internal configuration example of an image accumulation buffer management unit in the feature region tracking processing device shown in FIG. 1.

FIG. 3A is a flowchart of a motion example of a feature region tracking processing device according to a first embodiment of the present embodiment.

FIG. 3B is a flowchart of a motion example of the feature region tracking processing device according to the first embodiment of the present embodiment.

FIG. 4A is a flowchart of a motion example of a change operation and an addition operation of position designation of a feature region tracking processing device according to a second embodiment of the present embodiment.

FIG. 4B is a flowchart of a motion example of the change operation and the addition operation of the position designation of the feature region tracking processing device according to the second embodiment of the present embodiment.

FIG. 4C is a flowchart of a motion example of the change operation and the addition operation of the position designation of the feature region tracking processing device according to the second embodiment of the present embodiment.

FIG. 5A is an explanatory diagram of a temporary stop motion of a position designation operation in the feature region tracking processing device.

FIG. 5B is an explanatory diagram of a position designation motion of the position designation operation in the feature region tracking processing device.

FIG. 5C is an explanatory diagram of an image displayed after position designation in the feature region tracking processing device.

FIG. 5D is an explanatory diagram of an image of vital information displayed after the position designation in the feature region tracking processing device.

FIG. 6A is an explanatory diagram of a motion of the change operation of the position designation of the feature region in the feature region tracking processing device.

FIG. 6B is an explanatory diagram of a motion of a designation operation to a position to be changed in the feature region tracking processing device.

FIG. 6C is an explanatory diagram of an image displayed after the position change of the feature region in the feature region tracking processing device.

FIG. 6D is an explanatory diagram of an image of the vital information displayed after the position change of the feature region in the feature region tracking processing device.

FIG. 7A is an explanatory diagram of a motion of an addition operation the feature region in the feature region tracking processing device.

FIG. 7B is an explanatory diagram of a motion of designation operation of a position of the feature region to be added in the feature region tracking processing device.

FIG. 7C is an explanatory diagram of an image displayed after the feature region is added in the feature region tracking processing device.

FIG. 7D is an explanatory diagram of an image of the vital information displayed after the feature region is added in the feature region tracking processing device.

### DESCRIPTION OF EMBODIMENTS

Hereinafter, embodiments specifically disclosing a feature region tracking processing method, a vital information estimating method using the feature region tracking processing method, a feature region tracking processing device, and a vital information estimating device using the feature region tracking processing device according to the present disclosure will be described in detail with reference to the drawings as appropriate. However, unnecessarily detailed description may be omitted. For example, detailed description of a well-known matter or repeated description of substantially the same configuration may be omitted. This is to avoid unnecessary redundancy in the following description and to facilitate understanding of those skilled in the art. The accompanying drawings and the following description are provided for a thorough understanding of the present disclosure for those skilled in the art, and are not intended to limit the subject matter in the claims. As an example of the embodiment, the feature region tracking processing method and the feature region tracking processing device perform tracking processing on a feature region including a face, for example, using a camera image in which a subject (for example, a person or the like) is photographed, and extract vital information on the subject.

The feature region tracking processing device according to the embodiment is, for example, a data processing terminal such as a desktop or laptop personal computer (PC), a smartphone, a mobile phone, a tablet terminal, or a personal digital assistant (PDA), and may have a camera function of photographing the subject.

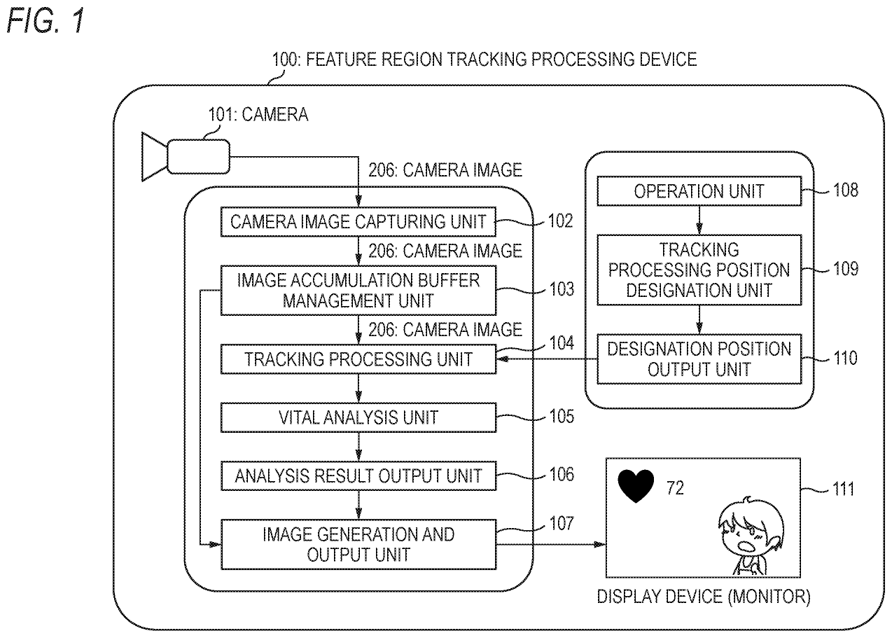

FIG. 1 is a configuration diagram showing an internal configuration example of a feature region tracking processing device 100 according to the present embodiment.

The feature region tracking processing device 100 according to the present embodiment shown in FIG. 1 includes a camera 101, a camera image capturing unit 102, an image accumulation buffer management unit 103, a tracking processing unit 104, a vital analysis unit 105, an analysis result output unit 106, an image generation and output unit 107, an operation unit 108, a tracking processing position designation unit 109, a designation position output unit 110, and a display device 111. The camera image capturing unit 102, the image accumulation buffer management unit 103, the tracking processing unit 104, the vital analysis unit 105, the analysis result output unit 106, the image generation and output unit 107, the tracking processing position designation unit 109, and the designation position output unit 110 are executed, for example, by a processor such as a field programmable gate array (FPGA) or a central processing unit (CPU). The processor functions as a control unit of the feature region tracking processing device 100, and cooperates with a memory (not shown) built in the feature region tracking processing device 100 to perform various types of processing (for example, processing executed by each of the camera image capturing unit 102, the image accumulation buffer management unit 103, the tracking processing unit 104, the vital analysis unit 105, the analysis result output unit 106, the image generation and output unit 107, the tracking processing position designation unit 109, and the designation position output unit 110) and control of the processing of each of the units.

The camera 101 that photographs a moving image of the subject may not be included in the feature region tracking processing device 100, and for example, may be directly connected to the feature region tracking processing device 100 by a cable or may be connected to the feature region tracking processing device 100 via a network. The network is the Internet or an intranet connected using a wireless network or a wired network as an interface. The wireless network is, for example, a wireless local area network (LAN), a wireless wide area network (WAN), 3G, long term evolution (LTE), or wireless gigabit (WiGig). The wired network is, for example, IEEE 802.3 or ETHERNET (registered trademark).

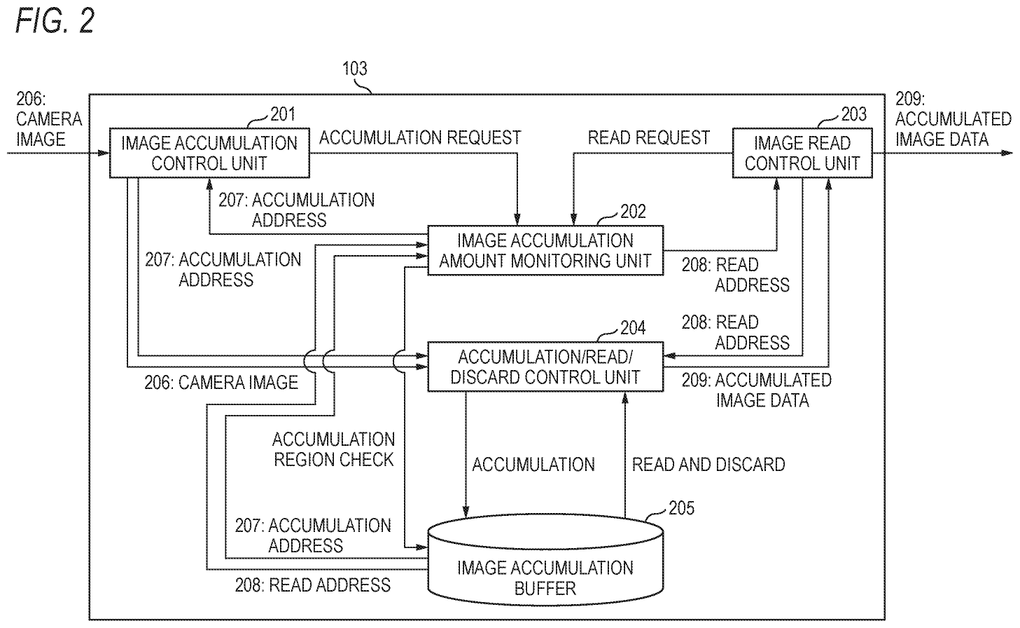

The camera image capturing unit 102 successively inputs (acquires) a camera image 206 (shown in FIG. 2) photographed by the camera 101 from the camera 101, and outputs the input camera image 206 to the image accumulation buffer management unit 103.

FIG. 2 is a configuration diagram showing an internal configuration example of the image accumulation buffer management unit in the feature region tracking processing device shown in FIG. 1.

The image accumulation buffer management unit 103 according to the present embodiment includes an image accumulation control unit 201, an image accumulation amount monitoring unit 202, an image read control unit 203, an accumulation/read/discard control unit 204, and an image accumulation buffer 205 shown in FIG. 2.

The image accumulation control unit 201 sends an accumulation request for the camera image 206 captured by the camera image capturing unit 102 (see FIG. 1) to the image accumulation amount monitoring unit 202, and acquires an accumulation address 207 from the image accumulation amount monitoring unit 202. Then, after acquiring the accumulation address 207, the image accumulation control unit 201 outputs the camera image 206 and the accumulation address 207 to the accumulation/read/discard control unit 204.

The image accumulation amount monitoring unit 202 monitors an accumulation region of the image accumulation buffer 205. Specifically, for example, when the image accumulation amount monitoring unit 202 receives the accumulation request from the image accumulation control unit 201, the image accumulation amount monitoring unit 202 checks whether the image accumulation buffer 205 that is the accumulation region is full (in other words, whether there is a predetermined amount of space in the accumulation region). When the image accumulation amount monitoring unit 202 confirms that the image accumulation buffer 205 is not full (in other words, there is the predetermined amount of space in the accumulation region), the image accumulation amount monitoring unit 202 acquires the accumulation address 207 from the image accumulation buffer 205 and outputs the accumulation address 207 to the image accumulation control unit 201. When the image accumulation amount monitoring unit 202 receives a read request for accumulated image data 209 accumulated in the image accumulation buffer 205 from the image read control unit 203, the image accumulation amount monitoring unit 202 checks whether the accumulated image data 209 is present in the image accumulation buffer 205. When the image accumulation amount monitoring unit 202 confirms that the accumulated image data 209 is present, the image accumulation amount monitoring unit 202 acquires a read address 208 of the accumulated image data 209 from the image accumulation buffer 205, and outputs the read address 208 to the image read control unit 203.

The image read control unit 203 reads the accumulated image data 209 accumulated in the image accumulation buffer 205, and outputs the accumulated image data 209 to the image generation and output unit 107 (see FIG. 1). Specifically, for example, the image read control unit 203 sends the read request for the accumulated image data 209 to be read to the image accumulation amount monitoring unit 202, and acquires the read address 208 assigned to the accumulated image data 209 by the image accumulation amount monitoring unit 202. The image read control unit 203 sends the read address 208 to the accumulation/read/discard control unit 204, acquires the accumulated image data 209 read by the accumulation/read/discard control unit 204 based on the read address 208, and outputs the accumulated image data 209 to the image generation and output unit 107.

The accumulation/read/discard control unit 204 controls accumulation of the camera image 206 in the image accumulation buffer 205, read of the accumulated image data 209 from the image accumulation buffer 205, and discard (in other words, deletion) of the accumulated image data 209 accumulated in the image accumulation buffer 205. Specifically, for example, when the accumulation/read/discard control unit 204 receives an instruction to accumulate the camera image 206 by the image accumulation control unit 201, the accumulation/read/discard control unit 204 accumulates the camera image 206 in the image accumulation buffer 205. For example, when the accumulation/read/discard control unit 204 receives an instruction to read out the accumulated image data 209 from the image read control unit 203, the accumulation/read/discard control unit 204 reads out the accumulated image data 209 from the image accumulation buffer 205 and outputs the accumulated image data 209 to the image read control unit 203. For example, when a user performs an operation of discarding the accumulated image data 209 using the operation unit 108 (see FIG. 1), the accumulation/read/discard control unit 204 discards (that is, deletes) the designated accumulated image data 209 from the image accumulation buffer 205.

Returning to FIG. 1, when the user performs an operation of starting the tracking processing on a feature region designated on an image (for example, a camera image) displayed on the display device 111 by the operation unit 108, the tracking processing unit 104 starts the tracking processing on the feature region. Here, the tracking processing on the feature region is, for example, processing of designating a position of the feature region in each camera image (frame) input via the camera image capturing unit 102 at any time after a tracking processing start position is designated in a certain camera image input successively (that is, after the feature region is determined) as the tracking processing performed by the tracking processing unit 104.

The user can operate the feature region tracking processing by using the operation unit 108. That is, the operation unit 108 can receive an operation of the feature region tracking processing by the user. When the designation of the tracking processing start position is operated by the user, the operation unit 108 outputs an instruction of designating the tracking processing start position to the tracking processing position designation unit 109. The operation of the operation unit 108 may be a mouse operation by a PC or a touch panel operation.

When receiving information on the tracking processing start position designated by the user operation from the operation unit 108, the tracking processing position designation unit 109 outputs the information designated by the user (that is, the information on the feature region that is the tracking processing start position) to the designation position output unit 110.

The designation position output unit 110 outputs the information on the feature region and the instruction of the tracking processing on the feature region which are output from the tracking processing position designation unit 109 to the tracking processing unit 104.

The vital analysis unit 105 analyzes pulse rate information of the subject (for example, a person) as an example of the vital information based on a change in a skin color of the subject in the feature region that is a target of the tracking processing in tracking processing unit 104. An analysis method in the vital analysis unit 105 is not limited to the change in the skin color of the subject. For example, the analysis may be performed based on a change in a pupil of an eyeball. Further, the vital information analyzed by vital analysis unit 105 is not limited to the pulse rate information. For example, the vital information may be a body temperature, a respiratory rate, or a perspiration state of the subject.

The analysis result output unit 106 outputs, based on an analysis result output from the vital analysis unit 105, the pulse rate information corresponding to the analysis result to the image generation and output unit 107.

The image generation and output unit 107 superimposes the pulse rate information acquired by the analysis result output unit 106 on the camera image 206 photographed by the camera 101, and generates an image to be displayed on the display device 111.

The display device 111 displays the image generated and output by the image generation and output unit 107.

### First Embodiment

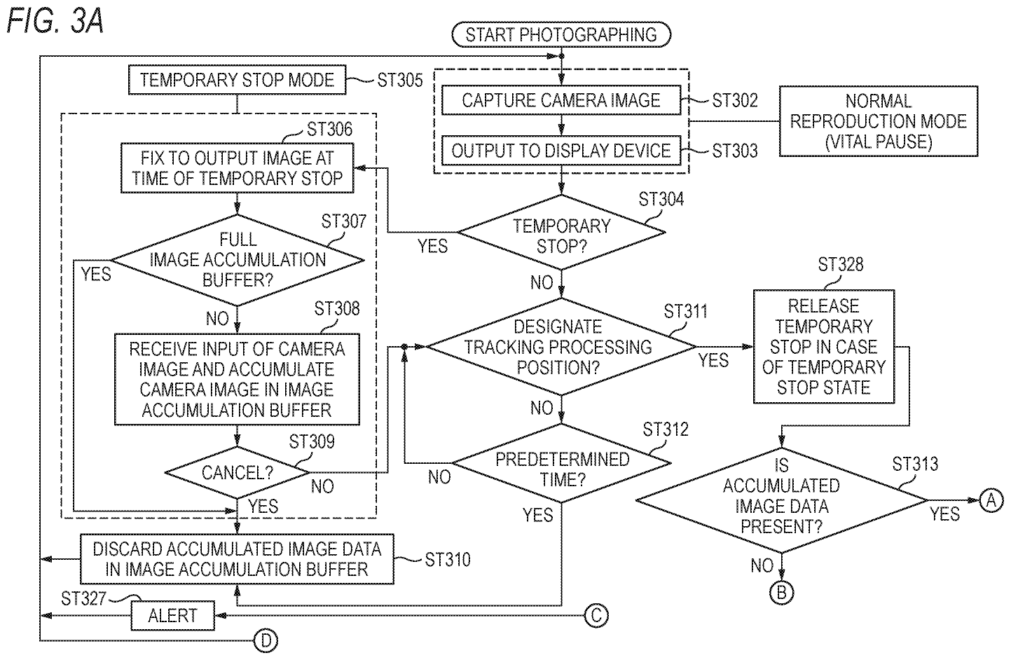

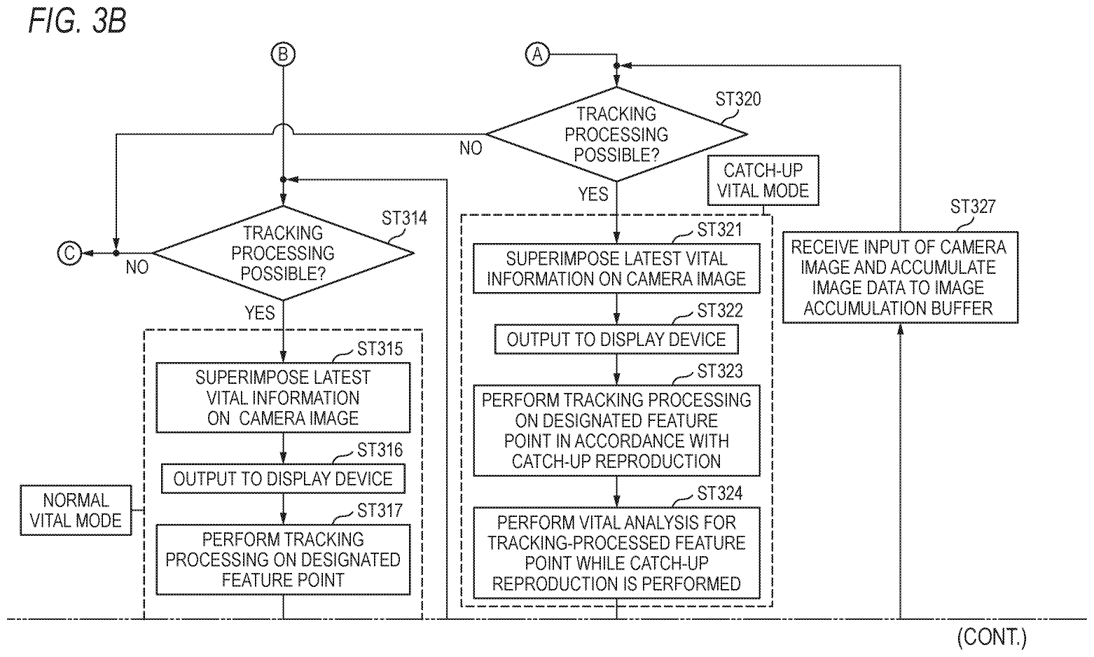

Next, an example of a motion procedure of the feature region tracking processing device 100 according to the present embodiment will be described with reference to FIG. 3. FIGS. 3A and 3B are flowcharts of a motion example of the feature region tracking processing device according to a first embodiment of the present embodiment.

In FIG. 3A, the feature region tracking processing device 100 in FIG. 1 shifts to a normal reproduction mode (vital pause) when the photographing is started. In the normal reproduction mode, the camera image 206 photographed by the camera 101 is captured by the camera image capturing unit 102 (ST302), and is output to and displayed on the display device 111 (ST303). That is, the camera image 206 photographed by the camera 101 is reproduced by the display device 111. In the normal reproduction mode, the vital information on the subject (for example, a person) is not acquired.

When the user selects temporary stop by the operation unit 108 during the normal reproduction mode (Yes in ST304), the feature region tracking processing device 100 shifts to a temporary stop mode (ST305). Specifically, in the temporary stop mode, a screen displayed on the display device 111 is fixed to an output image at a time of the temporary stop (ST306). That is, the camera image 206 reproduced when the user performs the temporary stop operation using the operation unit 108 is fixedly displayed on the display device 111.

When the temporary stop is selected, the image accumulation buffer management unit 103 checks whether the image accumulation buffer 205 is full (that is, whether there is the predetermined amount of space in the accumulation region). When the image accumulation buffer 205 is full (that is, there is no predetermined amount of space in the accumulation region) (Yes in ST307), the accumulated image data 209 in the image accumulation buffer 205 is discarded (ST310), and the feature region tracking processing device 100 shifts to the normal reproduction mode of step ST302. On the other hand, when the image accumulation buffer 205 is not full (that is, there is the predetermined amount of space in the accumulation region) (No in ST307), the image accumulation control unit 201 receives the input of the camera image 206 from the camera image capturing unit 102, and accumulates the camera image 206 in the image accumulation buffer 205 (ST308).

The temporary stop state is released by a cancel operation (Yes in ST309) performed by the user using the operation unit 108. When the user performs the cancel operation (Yes in ST309), the accumulated image data 209 in the image accumulation buffer 205 accumulated from the time of the temporary stop is discarded (ST310), and the feature region tracking processing device 100 shifts to the normal reproduction mode of step ST302. When the user does not perform the cancel operation of the temporary stop (No in ST309) and designates the tracking processing start position (Yes in ST311), the temporary stop state is also released (ST328).

Further, the user can designate the tracking processing start position without performing the temporary stop operation (No in ST304), and it is needless to say that the user can easily and accurately designate the tracking processing start position by performing the temporary stop. For example, when the user designates the tracking processing start position using the operation unit 108, if the subject moves and the designation is difficult to be performed, the user can easily designate the tracking processing start position by performing the temporary stop operation using the operation unit 108 during the normal reproduction mode and fixing the screen displayed on the display device 111 to the output image (reproduced image) at the time of the temporary stop.

When the user designates the tracking processing start position (Yes in ST311), the temporary stop is released in a case of the temporary stop state (ST328), the tracking processing position designation unit 109 designates the feature region of the subject, and the designation position output unit 110 outputs the information on the feature region designated by the tracking processing position designation unit 109 and the instruction of the tracking processing on the feature region to the tracking processing unit 104.

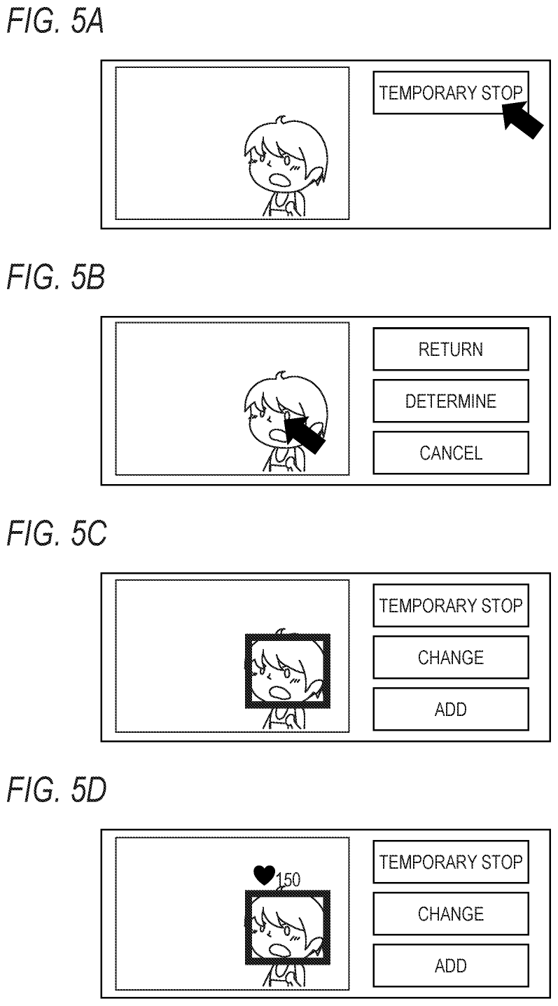

Here, a motion of designating the tracking processing start position in the feature region tracking processing device 100 will be described with reference to FIGS. 5A to 5D.

FIGS. 5A to 5D are diagrams showing an example of a motion method of designating the tracking processing start position in the operation unit 108.

When the user presses a temporary stop button on an operation screen (that is, the screen on which the camera image 206 is displayed on the display device 111) during the normal reproduction mode, the operation screen is fixed to the output image at the time of the temporary stop (see FIG. 5A). FIG. 5A is an explanatory diagram of a temporary stop motion of a position designation operation in the feature region tracking processing device 100. In the operation screen in the temporary stop state, the user moves a cursor to the subject, selects the feature region desired to be tracked by clicking or tapping the feature region, and presses a determination button, whereby the tracking processing start position designation is completed (see FIG. 5B). FIG. 5B is an explanatory diagram of a position designation motion of the position designation operation in the feature region tracking processing device 100. An image on which the tracking processing start position is superimposed is displayed on the operation screen in the temporary stop state (see FIG. 5C). FIG. 5C is an explanatory diagram of an image displayed after the position designation in the feature region tracking processing device. The feature region determined based on the selection of the tracking processing start position is displayed, for example, in a rectangular frame as shown in FIG. 5C. However, the feature region is not limited to being displayed in the rectangular frame. In a normal vital mode or a catch-up vital mode to be described later, after the operation screen of FIG. 5C is displayed, an operation screen on which latest vital information is superimposed is displayed (see FIG. 5D). FIG. 5D is an explanatory diagram of an image of the vital information displayed after the position designation in the feature region tracking processing device.

The above operation is merely an example, and does not limit the first embodiment. For example, the temporary stop operation may be omitted. An operation of pressing the determination button in the designation of the tracking processing start position may change a size of a designated range by clicking and dragging, may be substituted by an operation of pressing the determination button by double clicking, or may be omitted so as to be determined simultaneously with the designation of the range. Further, these operations may be performed by a keyboard operation.

In FIG. 3A, when the user does not designate the tracking processing start position within a predetermined time (Yes in ST312), the accumulated image data 209 in the image accumulation buffer 205 is discarded (ST310), and the feature region tracking processing device 100 shifts to the normal reproduction mode in step ST302. When the tracking processing start position is designated by the user (Yes in ST311) and the accumulated image data 209 is not accumulated in the image accumulation buffer 205 (No in ST313), the feature region tracking processing device 100 shifts to the normal vital mode (see FIG. 3B) from the normal reproduction mode.

In FIG. 3B, in the normal vital mode, the tracking processing unit 104 determines whether the tracking processing is possible without the feature region deviating from a photographing region of the camera 101 (in other words, without the subject moving vigorously) (ST314). When the tracking processing is possible without the feature region deviating from the photographing region of the camera 101 (Yes in ST314), the analysis result output unit 106 superimposes the latest vital information among the vital information that can be analyzed using the plurality of camera images 206 input from the camera image capturing unit 102 on the camera image 206 at any time (ST315), and the image generation and output unit 107 generates the image to be displayed and outputs and displays the image on the display device 111 (ST316). The tracking processing unit 104 performs the tracking processing on the feature region designated by the user (ST317), and the vital analysis unit 105 performs vital analysis for the tracking-processed feature region (ST318). In the determination of whether the tracking processing in the normal vital mode is possible by the tracking processing unit 104, it is determined that the tracking processing is impossible, for example, when the tracking processing start position deviates from the photographing region for a certain time or when acquisition of the vital information is interrupted (that is, becomes impossible) for the certain time due to the tracking processing start position being hidden by an obstacle or a significantly large movement that cannot be tracked although the tracking processing start position does not deviate from the photographing region. The certain time serving as a reference for determining whether the tracking processing is possible can be freely set by the user.

When the user does not instruct an operation of ending the normal vital mode with the operation unit 108 based on the vital information acquired by the vital analysis unit 105 (No in ST319), the tracking processing unit 104 determines again whether the tracking processing on the feature region is possible (ST314). When the operation of ending the normal vital mode is instructed (Yes in ST319), the feature region tracking processing device 100 shifts to the normal reproduction mode in step ST302.

When the feature region deviates from the photographing region and cannot be tracked (No in ST314), an alert is output from the tracking processing unit 104 (ST327), and the feature region tracking processing device 100 shifts to the normal reproduction mode in step ST302.

When the tracking processing start position is designated by the user (Yes in ST311) and the accumulated image data 209 is accumulated in the image accumulation buffer 205 (Yes in ST313), the feature region tracking processing device 100 shifts to the catch-up vital mode from the normal reproduction mode.

In the catch-up vital mode, with the accumulated image data 209 including the plurality of camera images 206 successively input from the camera image capturing unit 102 from the time of the temporary stop until the temporary stop state is released serving as a target, the image generation and output unit 107 performs catch-up reproduction (that is, sequentially reproduces the plurality of camera images 206 serving as the target from the old camera image to the latest camera image) so as to catch up with the latest camera image 206 from the old (specifically, at the time of the temporary stop) camera image 206 input by the camera image capturing unit 102.

The catch-up reproduction is a reproduction method having a reproduction speed higher than that of the normal reproduction, and the catch-up reproduction method may increase a speed of the processing (that is, the tracking processing on the feature region with the accumulated image data 209 serving as the target) of the accumulated image data 209, or may thin out frames of the accumulated image data 209 to be processed within a range in which the tracking processing on the feature region can be performed. Further, the user may freely set the catch-up speed.

In the catch-up vital mode, when the feature region can be tracked without deviating from the photographing region of the camera 101 (Yes in ST320), the analysis result output unit 106 superimposes the latest vital information on the camera image (ST321), and the image generation and output unit 107 generates the image to be displayed while performing the catch-up reproduction and outputs and displays the catch-up reproduction image on the display device 111 (ST322). In the determination of whether the tracking processing in the catch-up vital mode is possible by the tracking processing unit 104, it is determined that the tracking processing is impossible, for example, when the tracking processing start position deviates from the photographing region of the camera 101 or when the acquisition of the vital information is interrupted for the certain time due to the tracking processing start position being hidden by the obstacle or the significantly large movement that cannot be tracked although the tracking processing start position does not deviate from the photographing region of the camera 101. The certain time serving as the reference for determining whether the tracking processing is possible can be freely set by the user.

A starting point of the catch-up reproduction is not limited to the time of the temporary stop, and the user may select the accumulated image data at any time point between the time of the temporary stop and latest image data. Further, the image to be output and displayed on the display device 111 may be the display image in the normal reproduction mode instead of the catch-up reproduction image.

The tracking processing unit 104 performs the tracking processing on the feature region designated by the user in accordance with the catch-up reproduction (ST323), and the vital analysis unit 105 performs the vital analysis for the tracking-processed feature region while the catch-up reproduction is performed (ST324).

When the catch-up reproduction catches up with the latest image data (Yes in ST325), the feature region tracking processing device 100 shifts to the normal vital mode from the catch-up vital mode. When the catch-up reproduction does not catch up with the latest image data (No in ST325), the user determines whether to end the catch-up vital mode (ST326). When the catch-up vital mode is ended (Yes in ST326), the feature region tracking processing device 100 shifts to the normal vital mode from the catch-up vital mode. When the catch-up vital mode is not ended (No in ST326), the input of the successively photographed camera images is received, and the accumulated image data which is not yet read among the accumulated image data accumulated in the temporary stop mode is read (ST327).

After step ST327, until the catch-up reproduction catches up with the latest image data (Yes in ST325), the feature region tracking processing device 100 repeats the determination of whether the tracking processing on the feature region is possible (ST320), the catch-up vital mode, and the accumulation of the camera image 206 (ST327).

As described above, the feature region tracking processing device 100 according to the present embodiment temporarily stops the output (for example, the reproduction) of the camera images successively acquired, accumulates, as the accumulated image data, the respective camera images successively acquired after the time of the temporary stop treating the time of the temporary stop as the starting point, receives the position designation in the camera image output at the time of the temporary stop, and when the position designation is received, sequentially performs the tracking processing on the feature region in the latest camera image among the camera image acquired at the time of the temporary stop included in the accumulated image data using the designated position as the feature region. At a timing at which the latest camera image is accumulated as the accumulated image data, the tracking processing on the feature region of the latest camera image is completed. In other words, the tracking processing on the feature region is started treating the camera image at the time of the temporary stop as the starting point, and the completion timing of the tracking processing on the feature region for the latest camera image is the same as (that is, catch up with) the timing at which the latest camera image is accumulated as the accumulated image data.

Accordingly, even when it is difficult to designate the tracking start position because the movement of the feature region designated for the subject is intense and it is difficult to perform the tracking processing in real time, it is easy to designate the feature region desired to be tracking-processed by temporarily stopping the reproduction of the camera image. Further, even when the feature region moves greatly while the user designates the feature region and the tracking processing becomes difficult, the feature region tracking processing device 100 performs the tracking processing on the feature regions in the camera images from the camera image at the time of the temporary stop to the latest image data (camera image) which is successively photographed and input using the accumulated image data so as to catch up with the timings at which the camera images are sequentially input, and thus the tracking processing can be easily performed and the tracking processing can be performed in real time. As a result, the feature region tracking processing device can facilitate operability of the user and perform the tracking processing on the feature region in real time.

### Second Embodiment

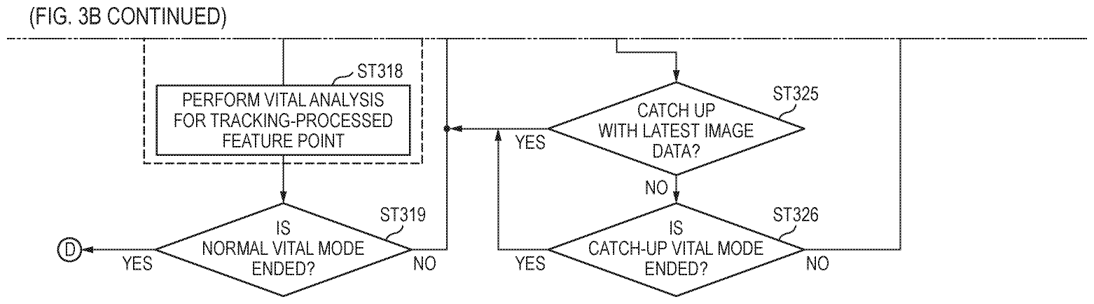

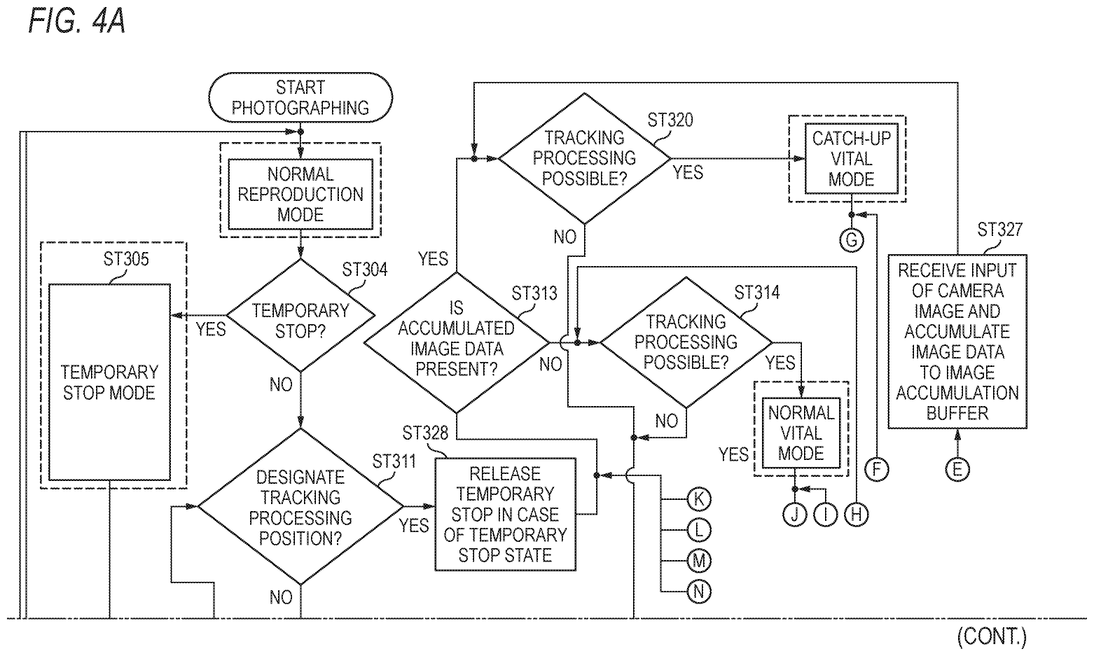

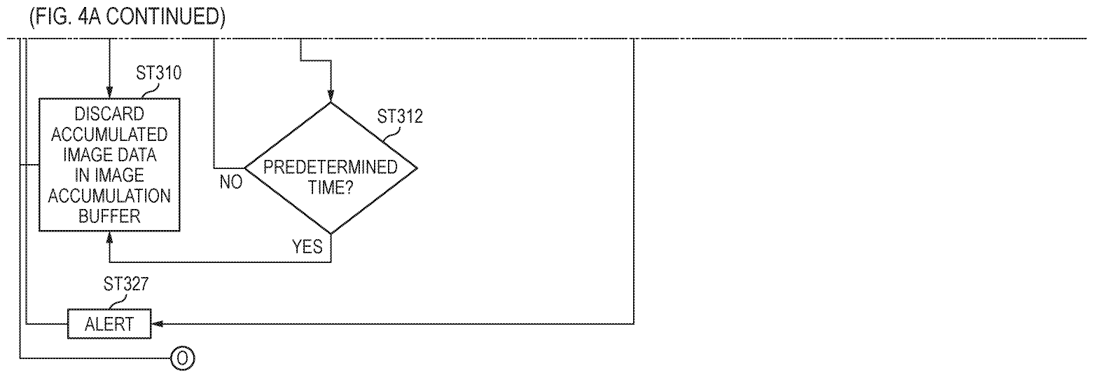

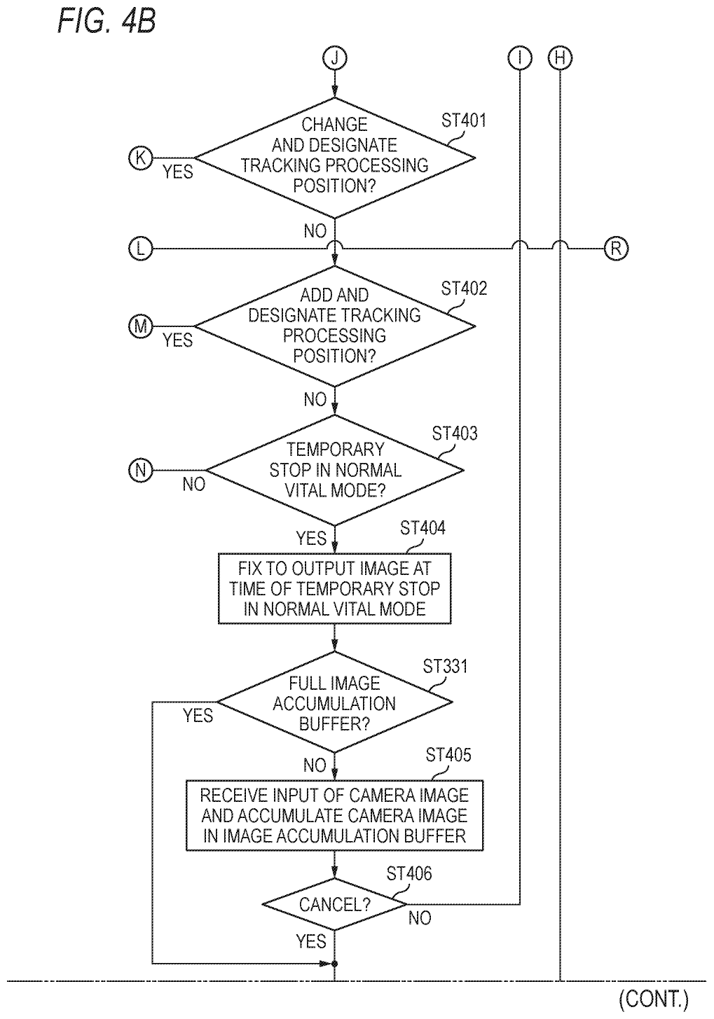

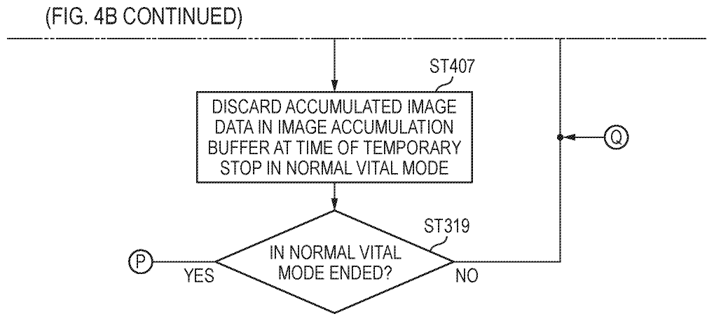

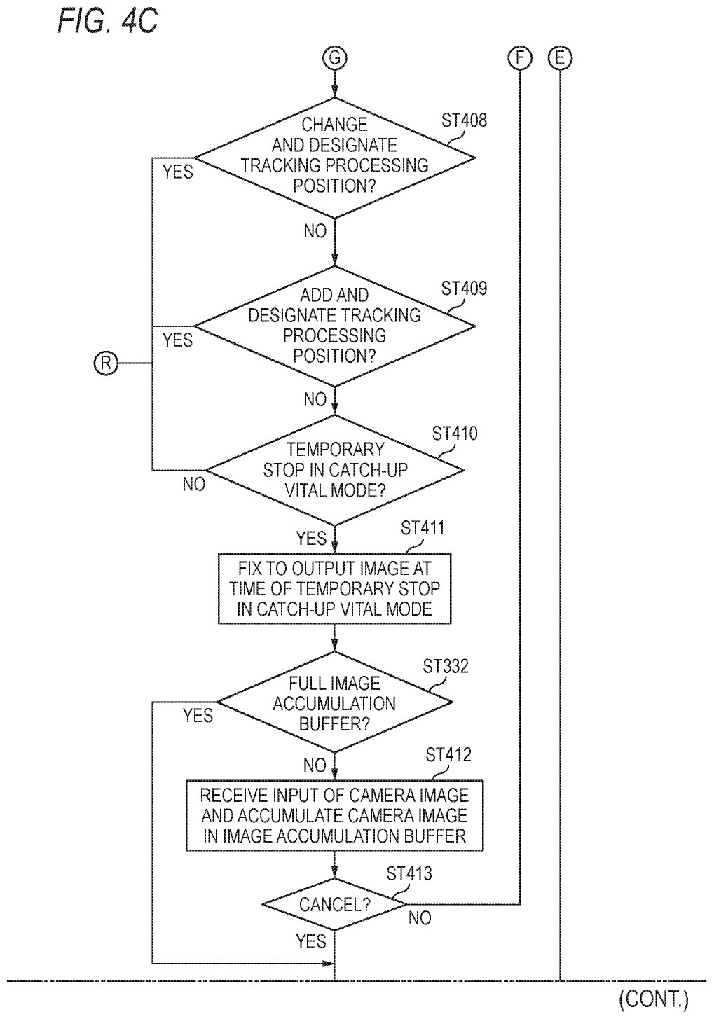

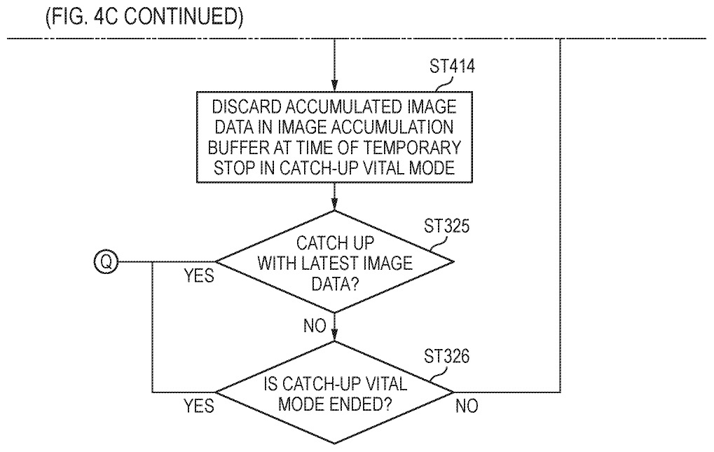

Next, an example of a motion procedure of changing or adding a tracking processing start position of the feature region tracking processing device 100 according to the present embodiment will be described with reference to FIGS. 4A, 4B, and 4C. FIGS. 4A, 4B, and 4C are flowcharts of a motion example of a change operation and an addition operation of the tracking processing start position of the feature region tracking processing device 100 according to a second embodiment of the present embodiment.

In the present second embodiment, the feature region tracking processing device 100 can change or add the tracking processing start position by an operation of a user during a normal vital mode or a catch-up vital mode. Therefore, in FIGS. 4A to 4C, flows from a start of photographing to ST318 or ST324 are the same as those of the first embodiment, and thus the description thereof will be omitted.

In the normal vital mode of the second embodiment shown in FIG. 4B, when the user changes (or adds) and designates the tracking processing start position (ST401 or ST402), there are a case in which the temporary stop in the normal vital mode is performed and a case in which the temporary stop in the normal vital mode is not performed. When the temporary stop in the normal vital mode is performed (ST409), the feature region tracking processing device 100 accumulates the camera image 206 from the temporary stop in the normal vital mode (ST405), and when the temporary stop in the normal vital mode is not performed, the feature region tracking processing device 100 performs vital analysis without accumulating the camera image 206.

Similarly, in the catch-up vital mode according to the present second embodiment, when the user changes (or adds) and designates the tracking processing start position (ST408 or ST409), there is a case in which the temporary stop in the catch-up vital mode is performed and a case in which the temporary stop in the catch-up vital mode is not performed in step ST410 to be described later. When the temporary stop in the catch-up vital mode is performed (ST410), the feature region tracking processing device 100 accumulates the camera image 206 from the temporary stop in the catch-up vital mode (ST412), and when the temporary stop in the catch-up vital mode is not performed, the feature region tracking processing device 100 performs the vital analysis without accumulating the camera image 206.

Hereinafter, a flow of changing or adding the tracking processing start position in the normal vital mode and the catch-up vital mode according to the present second embodiment will be described.

In FIG. 4B, when the user changes and designates the tracking processing start position in the normal vital mode (Yes in ST401), the feature region tracking processing device 100 checks whether the accumulated image data 209 is present (ST313), and determines whether the tracking processing start position can be tracked (ST314 or ST320). As a result, the feature region tracking processing device 100 shifts to the normal vital mode or the catch-up vital mode. When the user does not change the tracking processing start position (No in ST401), the user designates the addition of the tracking processing start position (ST402). When the user designates the tracking processing start position to be added (Yes in ST402), the feature region tracking processing device 100 checks whether the accumulated image data 209 is present (ST313), and determines whether the tracking processing start position can be tracked (ST314 or ST320). The feature region tracking processing device 100 shifts to the normal vital mode or the catch-up vital mode. When the user does not add the tracking processing start position (No in ST402), the feature region tracking processing device 100 selects whether to execute the temporary stop in the normal vital mode (ST403). Here, the case in which the accumulated image data 209 is present in step ST313 is assumed to be the case in which the temporary stop in the normal vital mode is performed in step ST403 as described above. Therefore, in the determination of whether the accumulated image data 209 is present (ST313) after the change of the tracking processing start position (Yes in ST401) and the addition of the tracking processing start position (Yes in ST402) performed first in a series of measurements, No is always selected (NO in ST313).

When the user does not perform the temporary stop in the normal vital mode (No in ST403), the feature region tracking processing device 100 checks whether the accumulated image data 209 is present (ST313), and determines whether the tracking processing start position can be tracked (ST314 or ST320). As a result, the feature region tracking processing device 100 shifts to the normal vital mode or the catch-up vital mode. When the temporary stop in the normal vital mode is performed (Yes in ST403), the image displayed on the display device 111 is fixed to an output image at a time of the temporary stop in the normal vital mode (ST404), and the image accumulation buffer management unit 103 checks whether the image accumulation buffer 205 is full (that is, whether there is the predetermined amount of space in the accumulation region). When the image accumulation buffer 205 is full (that is, there is no predetermined amount of space in the accumulation region) (Yes in ST331), the feature region tracking processing device 100 discards the accumulated image data 209 in the image accumulation buffer 205 at the time of the temporary stop in the normal vital mode (ST407). When the image accumulation buffer 205 is not full (that is, there is the predetermined amount of space in the accumulation region) (No in ST331), in the feature region tracking processing device 100, the image accumulation control unit 201 receives an input of the camera image 206 and accumulates the camera image 206 in the image accumulation buffer 205 (ST405).

A state of the temporary stop in the normal vital mode is released by a cancel operation (Yes in ST406) by the user. Even if the user designates the change of the tracking processing start position (Yes in ST401) or the addition of the tracking processing start position (Yes in ST402) without performing the cancel operation of the temporary stop in the normal vital mode (No in ST406), the temporary stop in the normal vital mode is released. When the user performs the cancel operation of the temporary stop in the normal vital mode (Yes in ST406), the accumulated image data 209 accumulated in the image accumulation buffer 205 from the temporary stop in the normal vital mode is discarded (ST407). After the temporary stop in the normal vital mode is released, the normal vital mode is continued, and when the user performs an operation of ending the normal vital mode (Yes in ST319), the feature region tracking processing device 100 shifts to the normal reproduction mode. When the user does not perform the operation of ending the normal vital mode (No in ST319), the normal vital mode is continued. After the normal vital mode is continued, the flow of step ST319 is repeated from the normal vital mode.

In FIG. 4C, when the user changes and designates the tracking processing start position in the catch-up vital mode (Yes in ST408) according to the present second embodiment, the feature region tracking processing device 100 checks whether the accumulated image data 209 is present (ST313), and determines whether the tracking processing start position can be tracked (ST314 or ST320). As a result, the feature region tracking processing device 100 shifts to the normal vital mode or the catch-up vital mode. When the user does not change the tracking processing start position (No in ST408), the user designates the addition of the tracking processing start position (ST409). When the user designates the tracking processing start position to be added (Yes in ST409), the feature region tracking processing device 100 checks whether the accumulated image data 209 is present (ST313), and determines whether the tracking processing start position can be tracked (ST314 or ST320). As a result, the feature region tracking processing device 100 shifts to the normal vital mode or the catch-up vital mode. When the user does not add the tracking processing start position (No in ST409), the feature region tracking processing device 100 selects whether to execute the temporary stop in the catch-up vital mode (ST410).

When the user does not perform the temporary stop in the catch-up vital mode (No in ST410), the feature region tracking processing device 100 checks whether the accumulated image data 209 is present (ST313), and determines whether the tracking processing start position can be tracked (ST314 or ST320). As a result, the feature region tracking processing device 100 shifts to the normal vital mode or the catch-up vital mode. When the temporary stop in the catch-up vital mode is performed (Yes in ST410), the image displayed on the display device 111 is fixed to an output image at a time of the temporary stop in the catch-up vital mode (ST411), and the image accumulation buffer management unit 103 checks whether the image accumulation buffer 205 is full (that is, whether there is the predetermined amount of space in the accumulation region). When the image accumulation buffer 205 is full (that is, there is no predetermined amount of space in the accumulation region) (Yes in ST332), the feature region tracking processing device 100 discards the accumulated image data 209 in the image accumulation buffer 205 at the time of the temporary stop in the catch-up vital mode (ST414). When the image accumulation buffer 205 is not full (that is, there is the predetermined amount of space in the accumulation region) (No in ST332), the image accumulation control unit 201 receives the input of the camera image 206 and accumulates the camera image 206 in the image accumulation buffer 205 (ST412).

A state of the temporary stop in the catch-up vital mode is released by the cancel operation (Yes in ST413) by the user. Even if the user designates the change of the tracking processing start position (Yes in ST408) or the addition of the tracking processing start position (Yes in ST409) without performing the cancel operation of the temporary stop in the catch-up vital mode (No in ST413), the temporary stop is released. When the user performs the cancel operation of the temporary stop in the catch-up vital mode (Yes in ST413), the accumulated image data 209 accumulated in the image accumulation buffer 205 from the temporary stop in the catch-up vital mode is discarded (ST414). After the temporary stop in the catch-up vital mode is released, when the catch-up vital mode continues and catch-up reproduction catches up with latest image data (Yes in ST325), the feature region tracking processing device 100 shifts to the normal vital mode. When the catch-up reproduction does not catch up with the latest image data (No in ST325), the user determines whether to end the catch-up vital mode (ST326), and when the user operates to end the catch-up vital mode (Yes in ST326), the feature region tracking processing device 100 shifts to the normal vital mode. When the user does not operate to end the catch-up vital mode (No in ST326), the image accumulation control unit 201 receives the input of the camera image 206 and accumulates the camera image 206 in the image accumulation buffer 205 (ST327). The accumulated image data 209 in which the catch-up reproduction is completed in the catch-up vital mode is sequentially discarded.

After step ST327, ST327 is repeated from the catch-up vital mode until the catch-up reproduction catches up with the latest image data (Yes in ST325).

The flows of changing the tracking processing start position and adding the tracking processing start position are not limited to the above, and for example, both step ST401 and step ST402 may be provided, or either one of them may be provided. When both step ST401 and step ST402 are provided, it doesn't matter which one is performed first. Further, the number of positions designated to be added is not limited to one, and a plurality of positions may be designated.

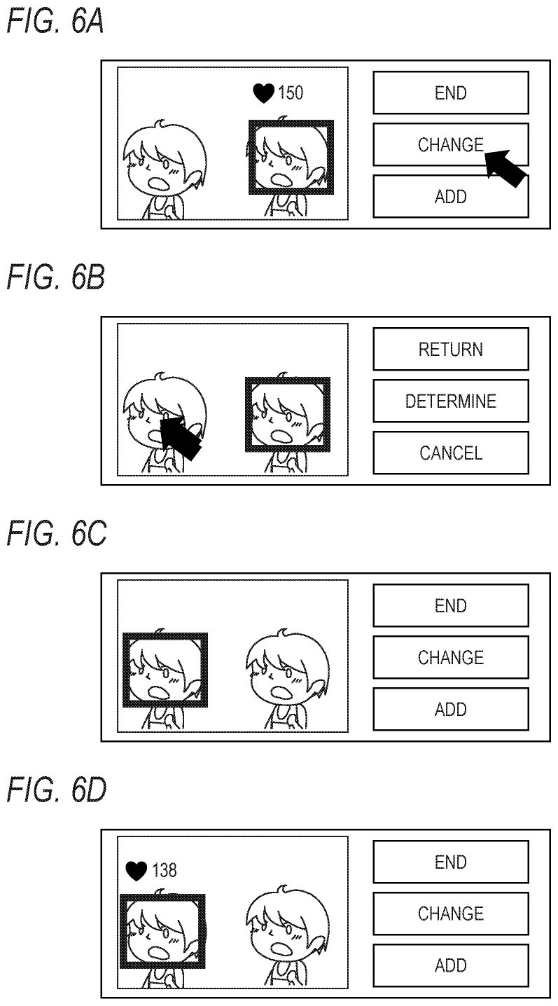

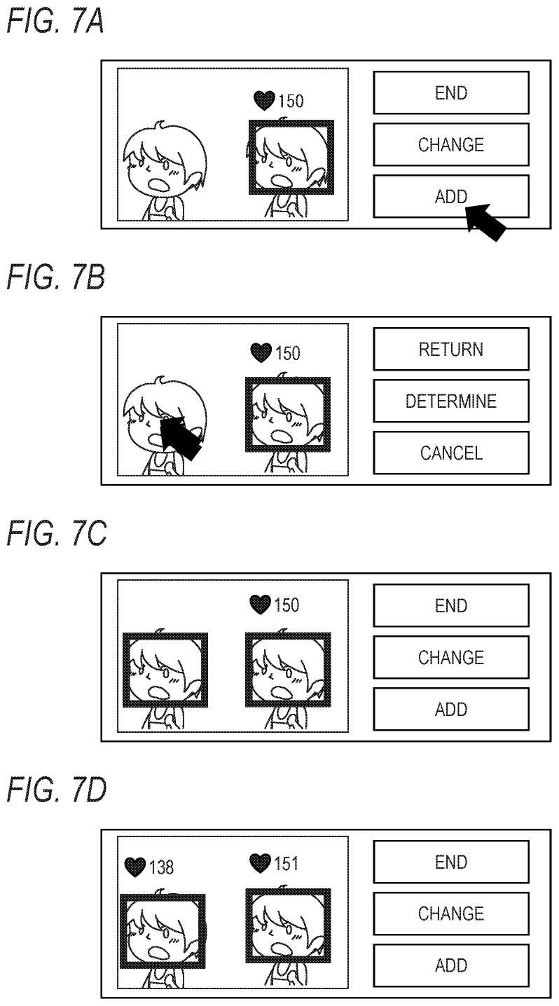

Here, the motions of changing the tracking processing start position or adding the tracking processing start position in the normal vital mode or the catch-up vital mode of the feature region tracking processing device 100 will be described with reference to FIGS. 6A to 6D and FIGS. 7A to 7D.

FIGS. 6A to 6D are diagrams showing an example of a motion method of changing the tracking processing start position in the operation unit 108.

When the user performs the operation to change the position of the feature region desired to be tracked, it is assumed that one or more feature regions are already designated, and thus the operation is performed on the normal vital mode or the catch-up vital mode in which one or more feature regions are already designated. During the normal vital mode or the catch-up vital mode, the user can move the cursor to a position to be changed by pressing a change button (see FIG. 6A). The user moves the cursor to any position and selects the feature region desired to be tracked by clicking or tapping the feature region (see FIG. 6B), and presses the determination button to complete the position change of the feature region, and the display of the feature region is changed from an original designated position to the changed designated position (see FIG. 6C). After the position of the feature region is changed, an operation screen on which the latest vital information is superimposed is displayed (see FIG. 6D).

The above operation method is merely an example, and does not limit the implementation. For example, in the above-described operation method, the change of the designated position of the feature region may be performed via the temporary stop. For example, the operation of pressing the change button by clicking and dragging may be substituted for the position of the feature region. Further, positions of a plurality of feature regions may be changed at the same time. The operation may be substituted by the operation of pressing the determination button by the double clicking, or may be omitted so as to be determined simultaneously with the designation of the change.

FIGS. 7A to 7D are diagrams showing an example of a motion method of adding the feature region desired to be tracked in the operation unit 108.

When the user performs the operation to add the feature region desired to be tracked, it is assumed that one or more feature regions are already designated, and thus the operation is performed on the normal vital mode or the catch-up vital mode in which one or more feature regions are already designated. During the normal vital mode or the catch-up vital mode, the user can move the cursor to a position of the feature region desired to be added by pressing an addition button (see FIG. 7A). The user moves the cursor to any position and selects the position of the feature region desired to be tracked by clicking or tapping the position (see FIG. 7B), and presses the determination button to complete the addition of the feature region desired to be tracked, and the added feature region is superimposed and displayed in addition to the original feature region (see FIG. 7C). After the feature region is added, an operation screen on which the latest vital information is superimposed on all the feature regions is displayed (see FIG. 7D).

The above operation method is merely an example, and does not limit the implementation. For example, in the above-described operation method, the addition of the feature region may be performed via the temporary stop. For example, an operation of pressing the addition button by double clicking on the designated position may be substituted for the addition of the feature region. Further, a plurality of feature regions may be added at the same time. The operation may be omitted so as to be determined simultaneously with the designation of the addition.

As described above, the feature region tracking processing device 100 according to the present embodiment changes the position of the feature region desired to be tracked or adds the feature region desired to be tracked in the normal vital mode or the catch-up vital mode.

Accordingly, the change operation by the user of the position of the feature region desired to be tracked can be easily performed, and the subject can be efficiently tracked. Further, by adding the feature region to be subjected to the tracking processing, it is possible to simultaneously perform the tracking processing on a plurality of subjects, and it is possible to compare states of the subjects in real time.

Finally, configurations, operations, and effects of the feature region tracking processing method, the vital information estimating method using the feature region tracking processing method, the feature region tracking processing device, and the vital information estimating device using the feature region tracking processing device according to the present disclosure will be listed.

The embodiment of the present disclosure is the feature region tracking processing method including: temporarily stopping an output of successively acquired camera images; accumulating, as accumulated image data, respective camera images successively acquired after a time of the temporary stop treating the time of the temporary stop as a starting point; receiving position designation in a camera image output at the time of the temporary stop; and when the position designation is received, sequentially performing, by using a designated position as a feature region, tracking processing on feature regions in camera images included in the accumulated image data from the camera image acquired at the time of the temporary stop to a latest camera image, in which the tracking processing on the feature region of the latest camera image is completed at a timing at which the latest camera image is accumulated as the accumulated image data.

The embodiment according to the present disclosure is the feature region tracking processing method in which in the tracking processing, the tracking processing on the feature region is performed for each of the camera images from the camera image acquired at the time of the temporary stop to the latest camera image.

In this method, the feature region tracking processing device temporarily stops the successively acquired camera images, accumulates the camera images as the accumulated image data starting treating the time of the temporary stop as the starting point, receives the position designation in the camera image acquired at the time of the temporary stop, and performs the tracking processing on the feature region so as to catch up with the latest image data from the time of the temporary stop using the designated position as the feature region.

Accordingly, even when the subject moves vigorously and it is difficult for the feature region tracking processing device to designate the feature region desired to be tracked and to perform the tracking processing in real time, the feature region tracking processing device temporarily stops the camera image, thereby facilitating the designation of the feature region desired to be tracked. Even when the feature region moves while the user designates the feature region and the tracking processing becomes difficult, the feature region tracking processing device performs the tracking processing on the feature region from the time of the temporary stop to the latest image data using the accumulated image data, and thus the tracking processing can be easily performed in real time. Furthermore, as a result, the feature region tracking processing device can facilitate the operability of the user and perform the tracking processing on the subject in real time.

The embodiment of the present disclosure is the feature region tracking processing method in which after a completion timing of the tracking processing on the feature region catches up with the timing at which the latest camera image is accumulated as the accumulated image data, the tracking processing is performed on the feature region in the latest camera image.

In this method, the feature region tracking processing device performs the tracking processing on the feature region in the latest image data after the tracking processing on the feature region catches up with the latest image data.

Accordingly, the feature region tracking processing device can always track the feature region in the latest image data even after the tracking processing on the feature region from the time of the temporary stop to the latest image data is completed. As a result, the real-time tracking processing can be performed on the feature region designated at the time of the temporary stop.

The embodiment of the present disclosure is the feature region tracking processing method in which the position designation is received during a certain time with the time of the temporary stop as the starting point, and the temporary stop is released when the certain time elapses.

In this method, the feature region tracking processing device receives the position designation of the feature region in the certain time, and releases the temporary stop when the certain time elapses.

Accordingly, even when the feature region tracking processing device enters a standby state without being operated after the user performs the temporary stop, the temporary stop is released after the certain time elapses, and thus the processing of the temporary stop is released, and a load on the other processing is reduced. As a result, the efficient feature tracking processing method can be performed.

The embodiment according to the present disclosure is the feature region tracking processing method in which the accumulated image data is accumulated for a predetermined time treating the time of the temporary stop as the starting point.

In this method, the feature region tracking processing device accumulates the accumulated image data for the predetermined time.

Accordingly, the feature region tracking processing device can prevent accumulation of unnecessary accumulated image data by limiting an accumulation time, and further, the load on other processing is reduced. As a result, it is possible to ensure the accumulation region and perform the efficient tracking processing method.

The embodiment according to the present disclosure is the feature region tracking processing method in which the predetermined time is a time from the time of the temporary stop to when the tracking processing catches up with the latest camera image.

In this method, the feature region tracking processing device accumulates the accumulated image data from the temporary stop of the camera image to when the tracking processing catches up with the latest image data.

Accordingly, even when new image data is input during the tracking processing on the feature region in the accumulated image data, the feature region tracking processing device accumulates the accumulated image data from the temporary stop to when the tracking processing on the feature region catches up with the latest image data, and therefore the tracking of the feature region can be performed up to the latest image data. As a result, the feature region tracking processing device can perform the tracking of the feature region in real time.

The embodiment according to the present disclosure is the feature region tracking processing method in which the certain time is a time from the time of the temporary stop to occurrence of the position designation.

In this method, the feature region tracking processing device releases the temporary stop when the position of the feature region is designated by the user at the time of the temporary stop of the camera image.

Accordingly, when the user designates the position of the feature region, the feature region tracking processing device releases the temporary stop, and thus the user does not need to release the temporary stop. Further, a burden on the tracking processing on the feature region is reduced. As a result, it is possible to simplify the operation of the user and perform the efficient tracking processing method.

The embodiment according to the present disclosure is the feature region tracking processing method in which the certain time is a time from the time of the temporary stop to the release of the temporary stop.

In this method, the feature region tracking processing device releases the temporary stop when the user cancels the temporary stop at the time of the temporary stop of the camera image.

Accordingly, the feature region tracking processing device can restart the temporary stop many times at the timing desired by the user. As a result, the operability of the tracking processing by the user is improved.

The embodiment according to the present disclosure is the feature region tracking processing method in which when the position designation is not received during the temporary stop, the accumulated image data is discarded.

In this method, when the user does not designate the position of the feature region while the camera screen is temporarily stopped, the feature region tracking processing device discards the accumulated image data from the temporary stop to the latest image data.

Accordingly, even when the unnecessary accumulated image data is accumulated without the user giving the instruction to track the feature region, the feature region tracking processing device discards the accumulated image data from the temporary stop to the latest image data, thereby preventing the accumulation of the unnecessary accumulated image data and further reducing the load on other processing. As a result, it is possible to ensure the accumulation region and perform the efficient tracking processing method.

The embodiment according to the present disclosure is the feature region tracking processing method in which after the temporary stop is released, the accumulated image data is reproduced so as to catch up with a timing at which the latest camera image is acquired.

In this method, the feature region tracking processing device reproduces the accumulated image data from the temporary stop release to the latest image data so as to catch up with the latest image data.

Accordingly, when the user wants to check progress information from the temporary stop to the latest image data, the feature region tracking processing device reproduces the accumulated image data so as to catch up with the latest image data, whereby the user can quickly check the progress information from the temporary stop to the latest image data. As a result, it is possible to assist the user to recognize the progress information from the temporary stop to the latest image data.

The embodiment according to the present disclosure is the feature region tracking processing method in which after the temporary stop is released, the image is reproduced from the successively acquired camera images.

In this method, the feature region tracking processing device releases the temporary stop and then reproduces the camera image from the camera images successively acquired.

Accordingly, the user can confirm a current state immediately after the temporary stop is released. As a result, the user can quickly acquire real-time information.

The embodiment according to the present disclosure is the feature region tracking processing method in which when the tracking processing becomes impossible for the predetermined time during the tracking processing, an alert is notified.

In this method, the feature region tracking processing device notifies the alert when the feature region becomes unable to be tracked during the tracking processing on the feature region.

Accordingly, the feature region tracking processing device can notify the user that the tracking processing on the feature region is impossible, and can prompt the user to re-designate the feature region or end the tracking processing. As a result, the user can quickly recognize that the tracking process is impossible, and thus it is possible to prevent a failure in which the evaluation ends without performing the tracking processing on the feature region, and to perform the accurate and efficient feature region tracking processing.

The embodiment according to the present disclosure is the feature region tracking processing method in which the feature region is analyzed using the accumulated image data to extract analysis data.

In this method, the feature region tracking processing device extracts the analysis data obtained by analyzing the feature region using the accumulated image data.

Accordingly, even when the subject moves vigorously and it is difficult for the feature region tracking processing device to designate the position to be analyzed, the feature region tracking processing device can analyze the feature region being tracking-processed. As a result, the user can easily and accurately analyze the feature region.

The embodiment according to the present disclosure is the feature region tracking processing method in which the analysis is performed so as to catch up with the latest camera image from the camera image acquired at the time of the temporary stop.

In this method, the feature region tracking processing device analyzes the feature region so as to catch up with the latest image data from the time of the temporary stop.

Accordingly, even when the feature region moves while the user designates the feature region and the analysis becomes difficult, the feature region tracking processing device analyzes the feature region from the time of the temporary stop to the latest image data using the accumulated image data, and thus the analysis can be easily performed in real time. As a result, the feature region tracking processing device can facilitate the operability of the user and analyze the subject in real time.

The embodiment according to the present disclosure is the vital information estimating method using the feature region tracking processing method, in which the analysis data is vital information.

In this method, the feature region tracking processing device uses the vital information as the analysis data.

Accordingly, the feature region tracking processing device can acquire the vital information of the subject by performing the tracking processing using the feature region tracking processing method.

The embodiment according to the present disclosure is the feature region tracking processing device including: a camera image capturing unit configured to temporarily stop output of successively acquired camera images; an image accumulation buffer management unit configured to accumulate, as accumulated image data, respective camera images successively acquired after a time of the temporary stop, the time of the temporary stop being a starting point; a tracking processing position designation unit configured to receive position designation in the camera image output at the time of the temporary stop; and a tracking processing unit configured to sequentially perform, when the position designation is received, by using a designated position as a feature region, tracking processing on feature regions in camera images included in the accumulated image data from the camera image acquired at the time of the temporary stop to a latest camera image, in which the tracking processing unit completes the tracking processing on the feature region of the latest camera image at a timing at which the latest camera image is accumulated as the accumulated image data.

In this method, the feature region tracking processing device controls the temporary stop of the camera image by the image capturing unit, controls the accumulation of the accumulated image data by the image accumulation buffer management unit, receives the position designation of the tracking processing start position by the tracking processing position designation unit, performs the tracking processing on the feature region in the accumulated image data by the designation position output unit, and performs the tracking processing on the feature region from the temporary stop to the latest image data by the tracking processing unit.

Accordingly, even when the subject moves vigorously and it is difficult for the feature region tracking processing device to designate the feature region desired to be tracked and to perform the tracking processing in real time, the feature region tracking processing device temporarily stops the camera image, thereby facilitating the designation of the feature region desired to be tracked. Even when the feature region moves while the user designates the feature region and the tracking processing becomes difficult, the feature region tracking processing device performs the tracking processing on the feature region from the time of the temporary stop to the latest image data using the accumulated image data, and thus the tracking processing can be easily performed in real time. As a result, the feature region tracking processing device can facilitate the operability of the user and perform the tracking processing on the subject in real time.

The embodiment according to the present disclosure is a vital information estimating device using the feature region tracking processing method, the vital information estimating device includes: a camera image capturing unit configured to temporarily stop output of successively acquired camera images; an image accumulation buffer management unit configured to accumulate, as accumulated image data, respective camera images successively acquired after a time of the temporary stop, the time of the temporary stop being a starting point; a tracking processing position designation unit configured to receive position designation in the camera image output at the time of the temporary stop; and a tracking processing unit configured to sequentially perform, when the position designation is received, by using a designated position as a feature region, tracking processing on feature regions in camera images included in the accumulated image data from the camera image acquired at the time of the temporary stop to a latest camera image, in which the tracking processing unit completes the tracking processing on the feature region of the latest camera image at a timing at which the latest camera image is accumulated as the accumulated image data.

In this method, the feature region tracking processing device controls the temporary stop of the camera image by the image capturing unit, controls the accumulation of the accumulated image data by the image accumulation buffer management unit, receives the position designation of the tracking processing start position by the tracking processing position designation unit, performs the tracking processing on the feature region in the accumulated image data by the designation position output unit, and performs the tracking processing on the feature region from the temporary stop to the latest image data and estimates the vital information by the tracking processing unit.

Accordingly, even when the subject moves vigorously and it is difficult for the feature region tracking processing device to designate the feature region desired to be tracked and to perform the tracking processing in real time, the feature region tracking processing device temporarily stops the camera image, thereby facilitating the designation of the feature region desired to be tracked. Even when the feature region moves while the user designates the feature region and the tracking processing becomes difficult, the feature region tracking processing device performs the tracking processing on the feature region from the time of the temporary stop to the latest image data using the accumulated image data, and thus the tracking processing can be easily performed in real time and the vital information can be estimated. As a result, the feature region tracking processing device can facilitate the operability of the user, perform the tracking processing on the subject in real time, and estimate the vital information.

Although various embodiments are described above with reference to the drawings, it is needless to say that the present disclosure is not limited to such examples. It will be apparent to those skilled in the art that various changes and modifications may be conceived within the scope of the claims. It is also understood that the various changes and modifications belong to the technical scope of the present invention.

The present application is based on Japanese Patent Application No. 2019-222366 filed on Dec. 9, 2019, the contents of which are incorporated herein by reference.

### INDUSTRIAL APPLICABILITY

The present disclosure is useful as the feature region tracking processing method and the feature region tracking processing device that extract the vital information of the subject in real time even when the subject moves vigorously.

### REFERENCE SIGNS LIST

100 feature region tracking processing device
101 camera
102 camera image capturing unit
103 image accumulation buffer management unit
104 tracking processing unit
105 vital analysis unit
106 analysis result output unit
107 image generation and output unit
108 operation unit
109 tracking processing position designation unit
110 designation position output unit
111 display device
201 image accumulation control unit
202 image accumulation amount monitoring unit
203 image read control unit
204 accumulation/read/discard control unit
205 image accumulation buffer
206 camera image
207 accumulation address
208 read address
209 accumulated image data

1. A feature region tracking processing method comprising:
temporarily stopping an output of successively acquired camera images;
accumulating, as accumulated image data, respective camera images successively acquired after a time of the temporary stop, the time of the temporary stop being a starting point;
receiving position designation in a camera image output at the time of the temporary stop; and
when the position designation is received, sequentially performing, by using a designated position as a feature region, tracking processing on feature regions in camera images included in the accumulated image data from the camera image acquired at the time of the temporary stop to a latest camera image, wherein
the tracking processing on the feature region of the latest camera image is completed at a timing at which the latest camera image is accumulated as the accumulated image data.

2. The feature region tracking processing method according to claim 1, wherein
in the tracking processing, the tracking processing on the feature region is performed for each of the camera images from the camera image acquired at the time of the temporary stop to the latest camera image.

3. The feature region tracking processing method according to claim 1, wherein
after a completion timing of the tracking processing on the feature region catches up with the timing at which the latest camera image is accumulated as the accumulated image data, the tracking processing is performed on the feature region in the latest camera image.

4. The feature region tracking processing method according to claim 1, wherein
the position designation is received during a certain time treating the time of the temporary stop as the starting point, and the temporary stop is released when the certain time elapses.

5. The feature region tracking processing method according to claim 1, wherein
the accumulated image data is accumulated for a predetermined time treating the time of the temporary stop as the starting point.

6. The feature region tracking processing method according to claim 5, wherein
the predetermined time is a time from the time of the temporary stop to when the tracking processing catches up with the latest camera image.

7. The feature region tracking processing method according to claim 4, wherein
the certain time is a time from the time of the temporary stop to occurrence of the position designation.

8. The feature region tracking processing method according to claim 4, wherein
the certain time is a time from the time of the temporary stop to the release of the temporary stop.

9. The feature region tracking processing method according to claim 1, wherein
when the position designation is not received during the temporary stop, the accumulated image data is discarded.

10. The feature region tracking processing method according to claim 1, wherein
after the temporary stop is released, the accumulated image data is reproduced so as to catch up with a timing at which the latest camera image is acquired.

11. The feature region tracking processing method according to claim 1, wherein
after the temporary stop is released, the image is reproduced from the successively acquired camera images.

12. The feature region tracking processing method according to claim 1, wherein
when the tracking processing becomes impossible for the predetermined time during the tracking processing, an alert is notified.

13. The feature region tracking processing method according to claim 1, wherein
the feature region is analyzed using the accumulated image data to extract analysis data.

14. The feature region tracking processing method according to claim 13, wherein
the analysis is performed so as to catch up with the latest camera image from the camera image acquired at the time of the temporary stop.

15. A vital information estimating method using the feature region tracking processing method according to claim 13, wherein
the analysis data is vital information.

16. A feature region tracking processing device comprising:
a camera image capturing unit configured to temporarily stop output of successively acquired camera images;
an image accumulation buffer management unit configured to accumulate, as accumulated image data, respective camera images successively acquired after a time of the temporary stop, the time of the temporary stop being a starting point;
a tracking processing position designation unit configured to receive position designation in the camera image output at the time of the temporary stop; and
a tracking processing unit configured to sequentially perform, when the position designation is received, by using a designated position as a feature region, tracking processing on feature regions in camera images included in the accumulated image data from the camera image acquired at the time of the temporary stop to a latest camera image, wherein
the tracking processing unit completes the tracking processing on the feature region of the latest camera image at a timing at which the latest camera image is accumulated as the accumulated image data.

17. A vital information estimating device using a feature region tracking processing method comprising:
a camera image capturing unit configured to temporarily stop output of successively acquired camera images;
an image accumulation buffer management unit configured to accumulate, as accumulated image data, respective camera images successively acquired after a time of the temporary stop, the time of the temporary stop being a starting point;
a tracking processing position designation unit configured to receive position designation in the camera image output at the time of the temporary stop; and
a tracking processing unit configured to sequentially perform, when the position designation is received, by using a designated position as a feature region, tracking processing on feature regions in camera images included in the accumulated image data from the camera image acquired at the time of the temporary stop to a latest camera image, wherein
the tracking processing unit completes the tracking processing on the feature region of the latest camera image at a timing at which the latest camera image is accumulated as the accumulated image data.
